(19) United States
(12) Patent Application Publication
(10) Pub. No.: US 2025/0054988 A1
(43) Pub. Date: Feb. 13, 2025

(54) PRIMER FOR BATTERY ELECTRODE

(71) Applicant: SOLVAY SPECIALTY POLYMERS ITALY S.P.A., Bollate (Milano) (IT)

(72) Inventors: Francesco Liberale, Pavia (IT); Riccardo Rino Pieri, Milano (IT); Maurizio Biso, Milano (IT); Marie-Pierre Labeau, Sevres (FR); Patrick Moreau, Saint-Denis (FR)

(73) Assignee: SOLVAY SPECIALTY POLYMERS ITALY S.P.A., Bollate (Milano) (IT)

(21) Appl. No.: 18/722,471

(22) PCT Filed: Dec. 15, 2022
(86) PCT No.: PCT/EP2022/086180

§ 371 Date: Jun. 20, 2024

(30) Foreign Application Priority Data
Dec. 20, 2021 (EP) 21306846.3

(51) Int. Cl. H01M 4/62; C09D 5/00; C09D 5/24; C09D 133/02; H01M 4/04; H01M 4/36; H01M 4/66; H01M 10/0525

(52) U.S. Cl. CPC H01M 4/623; C09D 5/002; C09D 5/24; C09D 133/02; H01M 4/0404; H01M 4/043; H01M 4/366; H01M 4/661; H01M 10/0525

(57) ABSTRACT

The present invention relates to a primer that improves adhesiveness between an electro active material and a current collector, and to an electrode comprising the same.

### CROSS-REFERENCE TO RELATED APPLICATIONS

This application claims priority to European application 21306846.3 filed on 20 Dec. 2021, the whole content of this application being incorporated herein by reference for all purposes.

### TECHNICAL FIELD

The present invention relates to a primer that improves the adhesiveness between a composition comprising an electro active material and a current collector, and to an electrode comprising the same.

### BACKGROUND ART

An electrochemical cell (also referred to as a “battery”) typically comprises a cathode and an anode, collectively referred to as electrodes. To manufacture such electrodes, electro active materials are deposited onto a conductive support, acting as current collector for the electrode. Maintaining an efficient electrical contact between the electro active material and the conductive support is necessary for the functioning of the electrochemical cell.

Such electrical contact can be provided, for example, via the use of at least one primer, which is deposited between the electro active material and the conductive support. Primers suitable for the manufacture of electrodes have been disclosed for example in WO 2009/054987 (Sion Power Corporation).

EP 2639863 (Zeon Corporation) discloses a positive electrode for secondary cell comprising a current collector, which is comprised of aluminium or an aluminium alloy, and a positive electrode active material layer, wherein the positive electrode active material layer contains a positive electrode active material, a water-based binder, an organic phosphonic acid compound, and a polyvalent metal compound.

### SUMMARY OF INVENTION

The Applicant perceived that despite the different attempts made in the art, there is still the need for providing an electrode wherein an outstanding adhesion between the electro active material and the current collector is achieved, without negatively affecting the electrochemical performances of the final electrode.

Facing such a technical problem, the Applicant surprisingly found that a copolymer [copolymer (A)]obtained by radical polymerization of at least one phosphorus-containing unsaturated monomer with acrylic acid and/or methacrylic acid can be advantageously used as primer to provide an outstanding adhesion between the electro active material and the current collector of a cathode.

The Applicant surprisingly found that such good adhesion can be achieved by using a small amount of said polymer (A), so that the electrochemical performances of the final electrode are not negatively affected.

Thus, in a first embodiment, the present invention relates to an electrode [electrode (E)]comprising:
a surface-modified metal substrate having at least one side that is at least partially chemically modified,
a first layer adhered to said at least one surface of said metal substrate, said first layer comprising at least one copolymer (A) as defined above, and
a second layer, adhered to said first layer, comprising at least a composition [composition (C_{EA})]comprising at least one electrode active material [compound (AM)] and at least one binder [binder (B)].

Said electrode (E) can be either a cathode (positive electrode) or an anode (negative electrode).

Preferably, said electrode (E) is a cathode (positive electrode).

In a second embodiment, the present invention relates to a method for manufacturing an electrode (E) as defined above, said method comprising:
step (1) of providing a metal substrate having at least one surface;
step (1b) of surface treatment of said at least one surface of said metal substrate to provide a surface-modified metal substrate having at least one side that is at least partially chemically modified;
step (2) of contacting at least one copolymer (A) with said at least one surface of said metal substrate, thus providing a first layer;
step (3) contacting an electrode-forming composition [composition (CE)]comprising at least one electrode active material [compound (AM)], at least one binder [binder (B)] and at least one solvent [solvent (S)] with said first layer.

In another embodiment, the present invention relates to an electrochemical device, preferably a secondary battery, comprising a positive electrode and a negative electrode, wherein at least one of said positive electrode and said negative electrode is the electrode (E) as defined above.

In a further embodiment, the present invention relates to the use of said copolymer (A) as a primer in a current collector of an electrochemical device.

### DESCRIPTION OF EMBODIMENTS

For the purpose of the present invention and in the following claims:
the term “electro-active material (AM)” is intended to denote a compound which is able to incorporate or insert into its structure and substantially release therefrom alkaline or alkaline-earth metal ions during the charging phase and the discharging phase of an electrochemical device. The compound (AM) is preferably able to incorporate or insert and release lithium ions;
the term “secondary battery” is intended to denote a rechargeable battery;
the terms “cathode” and “positive electrode” are used as synonyms;
the terms “anode” and “negative electrode” are used as synonyms.

Within the present invention, the nature of said metal substrate depends on whether the final electrode thereby provided is a positive electrode or a negative electrode.

Advantageously, when the electrode of the invention is a cathode (positive electrode), the metal substrate comprises, preferably consists of, at least one metal selected from the group consisting of aluminium (Al), nickel (Ni), titanium (Ti), and alloys thereof. Aluminium being preferred.

Advantageously, when the electrode of the invention is an anode (negative electrode), the metal substrate comprises, preferably consists of, silicon (Si) or at least one metal selected from the group consisting of lithium (Li), sodium (Na), zinc (Zn), magnesium (Mg), copper (Cu) and alloys thereof. Copper being preferred.

Preferably, said copolymer (A) is obtained by radical polymerization of:
at least one phosphorus-containing unsaturated monomer of formula (a) or (b) as represented below:

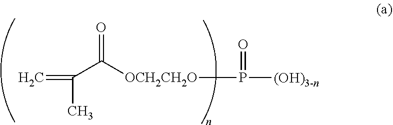

wherein n is 1 or 2;
(b) H₂C═CH—P(═O)—(OH)₂
with acrylic acid and/or methacrylic acid.

Preferably, copolymer (A) has a molecular weight of at least 7,500 Da, more preferably from 10 kDa to 1500 kDa, even more preferably from 10 kDa to 150 kDa, notably between 10 kDa and 100 kDa.

According to a preferred embodiment, said copolymer (A) is obtained by radical copolymerization of the phosphorus-containing unsaturated monomer of formula (b) above with acrylic acid.

According to this embodiment, the phosphorus-containing unsaturated monomer of formula (b) and the acrylic acid are in a molar ratio from 40:60 to 20:80, preferably 35:65 to 25:75 and even more preferably 30:70.

Preferably, according to this first embodiment, copolymer (A) has a molecular weight of from 25 kDa to 85 kDa.

According to a second preferred embodiment, said copolymer (A) is obtained by radical copolymerization of a mixture of 2-hydroxyethyl methacrylate phosphate, complying with formula (a) above wherein n is 1 and 2, with acrylic acid and methacrylic acid.

More preferably, said copolymer (A) is obtained by radical copolymerization of a mixture having the following molar ratio, based on the total quantity of acrylic acid, methacrylic acid and 2-hydroxyethyl methacrylate phosphates of Formula (a):
acrylic acid: from 65 to 90%, preferably from 80 to 90%, more preferably 83-85%,
methacrylic acid: from 5 to 30%, preferably from 5 to 15%, more preferably 11-13%,
2-hydroxyethyl methacrylate phosphates: from 2 to 12%, preferably from 2 to 10%, more preferably from 2 to 6% and even more preferably about 4%.

Preferably, according to this second embodiment, copolymer (A) has a molecular weight of from 15 kDa to 35 kDa.

Average molecular weights (typically weight average molecular weight) are measured by Size Exclusion Chromatography (SEC).

Advantageously, said first layer comprising compound (A) has a thickness below 1 μm.

The nature of said compound (AM) in composition (C_{EA}) depends on whether said composition is used in the manufacture of a positive electrode [electrode (Ep)] or a negative electrode [electrode (En)].

In the case of forming a positive electrode (Ep) for a Lithium-ion secondary battery, the compound (AM) may comprise a composite metal chalcogenide of formula LiMQ2, wherein M is at least one metal selected from transition metals such as Co, Ni, Fe, Mn, Cr and V or a metal such as Al and a mixture of thereof and Q is a chalcogen such as 0 or S. Among these, it is preferred to use a lithium-based composite metal oxide of formula LiMO2, wherein M is the same as defined above. Preferred examples thereof may include LiCoO2, LiNiO2, LiNixCo1-xO2 (0<x<1), LiNiaCobAlcO2 (a+b+c=1) and spinel-structured LiMn2O4.

As an alternative, still in the case of forming a positive electrode (Ep) for a Lithium-ion secondary battery, the compound (AM) may comprise a lithiated or partially lithiated transition metal oxyanion-based electro-active material of formula M1M2(JO4)fE1-f, wherein M1 is lithium, which may be partially substituted by another alkali metal representing less than 20% of the M1 metals, M2 is a transition metal at the oxidation level of +2 selected from Fe, Mn, Ni or mixtures thereof, which may be partially substituted by one or more additional metals at oxidation levels between +1 and +5 and representing less than 35% of the M2 metals, including 0, JO4 is any oxyanion wherein J is either P, S, V, Si, Nb, Mo or a combination thereof, E is a fluoride, hydroxide or chloride anion, f is the molar fraction of the JO4 oxyanion, generally comprised between 0.75 and 1.

The M1M2(JO4)fE1-f electro-active material as defined above is preferably phosphate-based and may have an ordered or modified olivine structure.

More preferably, the compound (AM) in the case of forming a positive electrode (Ep) has formula Li3-xM′yM″2-y(JO4)3 wherein 0≤x≤3, 0≤y≤2, M′ and M″ are the same or different metals, at least one of which being a transition metal, JO₄ is preferably P04 which may be partially substituted with another oxyanion, wherein J is either S, V, Si, Nb, Mo or a combination thereof. Still more preferably, the compound (AM) is a phosphate-based electro-active material of formula Li(FexMn1-x)PO4 wherein 0≤x≤1, wherein x is preferably 1 (that is to say, lithium iron phosphate of formula LiFePO4).

In the case of forming a negative composite electrode (En) for a Lithium-ion secondary battery, the compound (AM) may preferably comprise:
graphitic carbons able to intercalate Lithium, typically existing in forms such as powders, flakes, fibers or spheres (for example, mesocarbon microbeads) hosting Lithium;
Lithium metal;
Lithium alloy compositions, including notably those described in U.S. Pat. No. 6,203,944 (3M INNOVATIVE PROPERTIES CO.) and/or in WO 00/03444 (MINNESOTA MINING AND MANUFACTURING CO.);
Lithium titanates, generally represented by formula Li₄Ti₅O₁₂; these compounds are generally considered as “zero-strain” insertion materials, having low level of physical expansion upon taking up the mobile ions, i.e. Li⁺:
Lithium-silicon alloys, generally known as Lithium silicides with high Li/Si ratios, in particular Lithium silicides of formula Li_{4.4}Si;
Lithium-germanium alloys, including crystalline phases of formula Li_{4.4}Ge;
Lithium-tin and Lithium-antimony alloys.

In some embodiments, the carbon-based material may be, for example, graphite, such as natural or artificial graphite, graphene, carbon black or mixtures thereof.

The carbon-based material is preferably graphite.

The silicon-based compound may be one or more selected from the group consisting of chlorosilane, alkoxysilane, aminosilane, fluoroalkylsilane, silicon, silicon chloride, silicon carbide and silicon oxide. More particularly, the silicon-based compound may be silicon oxide or silicon carbide.

When present in compound (AM), the at least one silicon-based compound is comprised in the compound (AM) in an amount ranging from 1 to 30% by weight, preferably from 5 to 20% by weight with respect to the total weight of the compound (AM).

Preferably, when the electrode (E) is an anode, said binder (B) is selected from aqueous solutions of polyacrylic acid (PAA), carboxymethyl cellulose with styrene butadiene (CMC-SBR).

Preferably, when the electrode (E) is a cathode, said binder (B) is selected from semi-crystalline polymers or elastomers. Semi-crystalline polymers being more preferred.

As used herein, the term “semi-crystalline” means a fluoropolymer that has, besides the glass transition temperature Tg, at least one crystalline melting point on DSC analysis. For the purposes of the present invention a semi-crystalline fluoropolymer is hereby intended to denote a fluoropolymer having a heat of fusion determined according to ASTM D 3418 of advantageously at least 0.4 J/g, preferably of at least 0.5 J/g, more preferably of at least 1 J/g.

To the purpose of the invention, the term “elastomer” is intended to designate a true elastomer or a polymer resin serving as a base constituent for obtaining a true elastomer.

True elastomers are defined by the ASTM, Special Technical Bulletin, No. 184 standard as materials capable of being stretched, at room temperature, to twice their intrinsic length and which, once they have been released after holding them under tension for 5 minutes, return to within 10% of their initial length in the same time.

Preferably, the intrinsic viscosity of copolymer (A), measured in dimethylformamide at 25° C., is comprised between 0.05 I/g and 0.60 I/g, more preferably between 0.15 I/g and 0.50 I/g even more preferably between 0.20 I/g and 0.45 I/g.

The copolymer (A) of the present invention usually has a melting temperature (Tm) in the range from 120 to 200° C.

The melting temperature may be determined from a DSC curve obtained by differential scanning calorimetry (hereinafter, also referred to as DSC). In the case where the DSC curve shows a plurality of melting peaks (endothermic peaks), the melting temperature (Tm) is determined on the basis of the peak having the largest peak area.

Preferably, said binder (B) is selected from VDF-based polymers, more preferably VDF homopolymer or a copolymer of VDF with at least one (per)fluorinated monomer different from VDF and/or at least one (meth)acrylic monomer.

Non limitative examples of suitable (per)fluorinated monomers different from VDF are notably:
(a) C₂-C₈ partially or fully fluorinated olefins, such as tetrafluoroethylene (TFE), hexafluoropropylene (HFP), pentafluoropropylene and hexafluoroisobutylene;
(b) C₂-C₈ hydrogenated olefins different from VDF, such as vinyl fluoride (VF), trifluoroethylene (TrFE), perfluoroalkyl ethylenes of formula CH₂═CH—R_{f}, wherein R_{f} is a C₁-C₆ perfluoroalkyl group;
(c) C₂-C₈ chloro and/or bromo and/or iodo-fluoroolefins such as chlorotrifluoroethylene (CTFE);
(d) (per)fluoroalkylvinylethers (PAVE) of formula CF₂═CFOR_{f}, wherein R_{f} is a C₁-C₆ (per)fluoroalkyl group, e.g. CF₃, C₂F5, C₃F7.

Preferably, said at least one (meth)acrylic monomer complies with the following formula:

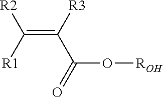

wherein
each of R1, R2, R3, equal or different from each other, is independently a hydrogen atom or a C₁-C₃ hydrocarbon group, and
R_{OH} is a hydrogen atom or a C₁-C₅ hydrocarbon moiety comprising at least one hydroxyl group.

More preferably said binder (B) is selected from the group comprising: VDF homopolymer and copolymer of VDF with at least one (meth)acrylic monomer as defined above.

Suitable binders (B) are commercially available for example from Solvay Specialty Polymers under the trade name Solef® PVDF.

Good results were obtained by performing, after said step (1) and before said step (2), a step (1b) of surface treatment of said at least one surface of said metal substrate.

As will be clear to those skilled in the art, said step (1b) of surface treatment comprises any surface treatment applied at least partly on the surface, wherein the surface treatments are selected from the group consisting of chemical modification, chemical etching, electrochemical etching, electrodeposition, chemically oxidized processes, coating, corona discharge.

For example, chemical etching can effectively roughen the surface of current collectors, which is favourable for improving adhesion and interfacial conductivity between electrodes and current collectors. Chemical modification can suitably be obtained by treatment with chemicals such as acids. Coating is another effective way to modify the surface of the metal substrate to achieve better performance in terms of enhanced electronic conductivity, adhesion towards the electrode and reduction of the corrosion. Reducing the corrosion is expected to improve the general performance of the battery by improving the good contact with the paste of the electrode by improving the electronic conductivity.

Good results have been obtained by performing said step (1b) via chemical etching, more preferably by contacting said at least one surface of said metal substrate in an acid solution, preferably nitric acid solution.

Preferably, said step of contact is performed by dipping said at least one surface into said acid solution.

Alternatively, if required by the circumstances, said contacting step can be performed by applying said acid solution onto at least one part of said at least one surface of said metal substrate. The person skilled in the art will understand that the area of said at least one surface of said metal surface subjected to etching can comprise the whole surface or at least a part of said surface.

Preferably, after step (1b) and before step (2), at least one step of cleaning and/or rinsing said at least one surface of said metal substrate is/are performed.

Preferably, when performed, said step of cleaning is performed with an organic solvent. More preferably, acetone.

Preferably, when performed, said step of rinsing is performed with water.

Preferably, said step (2) is performed by techniques known in the art, for example dip coating, spray coating, and the like.

Preferably, after said step (2) and before step (3), at least one step of rinsing is performed.

Preferably, said step (3) is performed by contacting an electrode-forming composition [composition (CE)] to said first layer.

Advantageously, said composition (CE) comprises at least one electroactive material [compound (AM)] as defined above, at least one binder (B) as defined above and at least one solvent [solvent (S)].

The solvent (S) may preferably be an organic polar one, examples of which may include: N-methyl-2-pyrrolidone (NPM), N,N-dimethylformamide, N,N-dimethylacetamide, dimethylsulfoxide, hexamethylphosphamide, dioxane, tetrahydrofuran, tetramethylurea, triethyl phosphate, trimethyl phosphate and mixtures thereof; and isobutyl-nitrile, isobutyl-butyrate, dibutylether, methyl isobutyl ketone, dibutyl carbonate, tert-butyl acetoacetate.

Preferably, after said step (3), at least one step of drying is performed.

Preferably, said step of drying is performed at a temperature from 50° C. to 150° C. and/or for a time from 30 seconds to 30 minutes. Such conditions can be properly selected by the person skilled in the art depending on the solvent to be evaporated. Preferably, the solvent to be evaporated is water.

Advantageously, after said step of drying, a loading between 5 and 40 mg/cm² for the final dried electrode was obtained, with a variation of +/−2 mg/cm².

More preferably, when said electrode is a cathode, a loading between 15 and 40 mg/cm² for the final dried electrode is obtained, with a variation of +/−2 mg/cm².

More preferably, when said electrode is an anode, a loading between 5 and 20 mg/cm² for the final dried electrode is obtained, with a variation of +/−2 mg/cm².

If required by the circumstances, after said step of drying, a step of compression can be performed, for example via a calendaring process. This additional step is useful to achieve the target porosity and density of the final electrode (E) of the invention.

For example, preferably, said step of compression can be performed by hot pressing, at a temperature from 25° C. and 130° C.

It will be clear that the composition directly adhered onto the first layer, also referred to as composition (C_{EA}), corresponds to the electrode-forming composition, also referred to as composition (CE), wherein the solvent has been at least partially removed during the manufacturing process of the electrode, for example in the step of drying as disclosed herein above and/or in the subsequent compression step.

The secondary battery of the invention is preferably an alkaline or an alkaline-earth metal secondary battery.

The secondary battery of the invention is more preferably a Lithium-ion secondary battery.

The electrochemical device according to the present invention, being preferably a secondary battery, comprises: a positive electrode, a negative electrode and a separator interposed between said positive electrode and said negative electrode, wherein at least one of the positive electrode and the negative electrode is the electrode (E) of the present invention.

An electrochemical device according to the present invention can be prepared by standard methods known to a person skilled in the art.

Should the disclosure of any patents, patent applications, and publications which are incorporated herein by reference conflict with the description of the present application to the extent that it may render a term unclear, the present description shall take precedence.

The invention will be described with reference to the following examples, whose purpose is merely illustrative and not intended to limit the scope of the invention.

### EXPERIMENTAL SECTION

### Samples Preparation

Conventional current collectors in aluminum were used.

LCO-based cathode slurry was prepared as follows. Solef® 5130 was dissolved at 6 wt. % in NMP. Once the dissolution was complete, LCO as active material and carbon additive SC65 (both in powder form) were added to the polymer solution. The relative amounts of the components [LCO:binder:SC65], as wt. %, are 97:1:2. The total solid content of the slurry was set at 75%.

Planetary mixing followed for 10 minutes in a sealed container in order to homogenize the mixture. The slurry was subjected to dispersion with a disperser at 2000 rpm for 50 minutes using a jagged impeller and under constant N₂ flux. The obtained slurry was casted with doctor blade technique on the Al current collectors, targeting a loading of 30 mg/cm² for the final dried electrode, accepting a variation of +/−2 mg/cm². The dying step consisted of 50 minutes at 90° C. in a vacuum oven, with the first 25 minutes in dynamic vacuum and the last 25 minutes in static vacuum.

### Reference—not According to the Present Invention

16 aluminum current collectors were used as reference, in order to have a baseline system for the measurements of peeling adhesion. A suitable amount of a LCO-based cathode slurry was casted onto each of said collectors and then drying was performed. Peeling test was performed as disclosed below. The average results are reported in Table 1.

### Comparison—not According to the Present Invention

25 aluminum current collectors were used as comparison. Each of said Al current collectors was subjected to etching with 5 wt. % HNO₃ solution, for 4 minutes at 40° C. A suitable amount of a LCO-based cathode slurry was casted onto each of said collectors and then drying was performed. Peeling test was performed as disclosed below. The average results are reported in Table 1.

### Collector A and Collector B According the Present Invention

6 and 9 aluminum current collectors were prepared according to the present invention. Each of said Al current collectors was subjected to etching with 5 wt. % HNO₃ solution, for 4 minutes at 40° C.

Then, each of them was dip coated with a solution of copolymer (A), as follows:
copolymer (A)-1: random copolymer obtained from copolymerization of a mixture of acrylic acid and vinyl phosphoric acid, in a molar ratio 70:30. Copolymer (A)-1 had a weight average molecular weight (Mw) in the range from about 30 to 80 kDa, as measured by GPC using the following conditions:
SEC was equipped with a MultiAngle Laser Light Scattering (MALLS) Mini Dawn TREOS detector and an Agilent concentration detector (RI detector). The SEC-MALLS system run on three columns Varian Aquagel OH mixed H, 8 μm, 3*30 cm at a flow rate of 1 mL/min and with the following mobile phase: 100% water, NaCl 100 mM, NaH₂PO₄ 25 mM, Na₂HPO₄ 25 mM buffer solution pH=7. Polymer samples were diluted down to 0.5 active wt % in the mobile phase for at least 4 hours then filtered in a Millipore filter 0.45 μm and 100 microliters were injected in the mobile phase flow. Absolute molar masses were obtained with the dn/dC of the poly(acrylic acid) equal to 0.1875 mL/g. As detector, the following was used: RI (Agilent concentration detector)+MALLS (MultiAngle Laser Light Scattering) Mini Dawn TREOS.
Copolymer (A)-2: random copolymer obtained from copolymerization of a mixture of acrylic acid, methacrylic acid, and 2-hydroxyethy methacrylate phosphates of Formula (a), in a molar ratio of about 83:13:4. Copolymer (A)-2 had a Mw in the range from about 20 to 30 kDa, measured by SEC chromatography using the following conditions:
SEC was equipped with a MultiAngle Laser Light Scattering (MALLS) Mini Dawn TREOS detector and an Agilent concentration detector (RI detector). The SEC-MALLS system run on three columns Varian Aquagel OH mixed H, 8 μm, 3*30 cm at a flow rate of 1 mL/min and with the following mobile phase: 85% water, 100 mM NaCl, 25 mM NaH₂PO₄, 25 Mm Na₂HPO₄—15% methanol. Polymer samples were diluted down to 0.5 active wt % in the mobile phase for at least 4 hours then filtered in a Millipore filter 0.45 μm and 100 microliters were injected in the mobile phase flow. Absolute molar masses were obtained with the dn/dC of the poly(acrylic acid) equal to 0.1875 mL/g.

The dipping was performed for 2 minutes at 45° C. Then, rinsing was then performed, followed by drying for 5 minutes starting from room temperature up to 100° C. A suitable amount of a standard LCO-based cathode slurry was casted on each treated Al current collector and then drying was performed.

Collectors (A) were obtained using copolymer (A)-1 and collectors (B) were obtained using copolymer (A)-2 above defined.

Peeling test was performed as disclosed below. The average results are reported in Table 1.

### Example 1—Adhesion Measurement

The peeling test was performed using an Instron 5943 instrument, according to the following procedure, at a speed=300 mm/min and a maximum load of the cell of 10N.

In 180° peel test, a constant 180 angle was maintained whilst the two glued components were peeled apart. The average load required to separate the two components, over the length of the specimen was recorded and expressed as N/m.

The coefficient of variation was also calculated as the ratio between the average load and the standard deviation.

TABLE 1

| | Average load | Coefficient of variation |
|---|---|---|
| Sample | (N/m) | (%) |
| Reference(*) | 15.24 | 8.30 |
| Comparison(*) | 18.92 | 13.22 |
| Collector A | 17.72 | 7.23 |
| Collector B | 21.77 | 9.90 |

(*)not according to the present invention

The results reported in Table 1 showed that the current collectors B according to the present invention showed an increase in the adhesion between the aluminum substrate and the electroactive material of about 15% in adhesion, while maintaining an acceptable coefficient of variation.

The results reported in Table 1 showed that the current collectors A according to the present invention showed an improved average load compared to the current collector indicated as Reference(*), while having a lower coefficient of variation compared to the current collector indicated as Comparison(*), meaning that the use of the primer allowed an increased uniformity with respect to the average load measured for the electrodes.

1. An electrode, electrode (E), comprising:
a surface-modified metal substrate having at least one side that is at least partially chemically modified,
a first layer adhered to said at least one surface of said metal substrate, said first layer comprising at least one copolymer, copolymer (A), obtained by radical polymerization of at least one phosphorus-containing unsaturated monomer with acrylic acid and/or methacrylic acid, and
a second layer, adhered to said first layer, comprising at least a composition, composition (C_{EA}), comprising at least one electrode active material, compound (AM), and at least one binder, binder (B).

2. The electrode (E) according to claim 1, wherein said copolymer (A) is obtained by radical polymerization of:
at least one phosphorus-containing unsaturated monomer of formula (a) or (b): 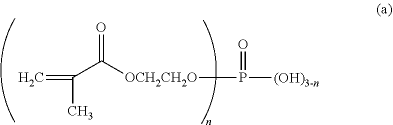
wherein n is 1 or 2;
(b) H₂C═CH—P(═O)—(OH)₂;
with acrylic acid and/or methacrylic acid.

3. The electrode (E) according to claim 2, wherein said copolymer (A) is obtained by radical copolymerization of the phosphorus-containing unsaturated monomer of formula (b) H₂C═CH—O—P(═O)—(OH)₂ with acrylic acid.

4. The electrode (E) according to claim 3, wherein said phosphorus-containing unsaturated monomer of formula (b) and the acrylic acid are in a molar ratio from 40:60 to 20:80.

5. The electrode (E) according to claim 2, wherein said copolymer (A) is obtained by radical copolymerization of:
a 2-hydroxyethyl methacrylate phosphate complying with formula (a), wherein n is 1,
a 2-hydroxyethyl methacrylate phosphate complying with formula (a) wherein n is 2, with
acrylic acid and methacrylic acid.

6. The electrode (E) according to claim 5, wherein said copolymer (A) is obtained by radical copolymerization of a mixture having the following molar ratio, based on the total quantity of acrylic acid, methacrylic acid and 2-hydroxyethyl methacrylate phosphates of Formula (a):
acrylic acid: from 65 to 90%,
methacrylic acid: from 5 to 30%,
2-hydroxyethyl methacrylate phosphates: from 2 to 12%.

7. The electrode (E) according tom claim 1, wherein said electrode is a positive electrode;
said metal substrate comprises at least one metal selected from the group consisting of aluminium (Al), nickel (Ni), titanium (Ti), and alloys thereof; said compound (AM) comprises:
(I) a composite metal chalcogenide of formula LiMQ2, wherein M is at least one metal selected from Co, Ni, Fe, Mn, Cr, V Al, and mixtures thereof and Q is a chalcogen, or
(II) a lithiated or partially lithiated transition metal oxyanion-based electro-active material of formula M1M2(JO4)fE1-f, wherein M1 is lithium, which is optionally partially substituted by another alkali metal representing less than 20% of the M1 metals, M2 is a transition metal at the oxidation level of +2 selected from Fe, Mn, Ni or mixtures thereof, which is optionally partially substituted by one or more additional metals at oxidation levels between +1 and +5 and representing less than 35% of the M2 metals, including 0, JO4 is any oxyanion wherein J is either P, S, V, Si, Nb, Mo or a combination thereof, E is a fluoride, hydroxide or chloride anion, f is the molar fraction of the JO4 oxyanion, generally comprised between 0.75 and 1; and/or
said binder (B) is selected from semi-crystalline polymers or elastomers.

8. The electrode (E) according to claim 7, wherein said binder (B) is selected from VDF-based polymers, selected from the group consisting of: VDF homopolymer and copolymer of VDF with at least one (per)fluorinated monomer different from VDF and/or at least one (meth)acrylic monomer.

9. The electrode (E) according to claim 1, wherein said electrode is a negative electrode; said metal substrate comprises silicon (Si) or at least one metal selected from the group consisting of lithium (Li), sodium (Na), zinc (Zn), magnesium (Mg), copper (Cu) and alloys thereof; said compound (AM) comprises:
graphitic carbons able to intercalate Lithium;
Lithium metal;
Lithium alloy compositions;
Lithium titanates;
Lithium-silicon alloys;
Lithium-germanium alloys;
Lithium-tin and Lithium-antimony alloys; and/or
said binder (B) is selected from aqueous solutions of polyacrylic acid, carboxymethyl cellulose with styrene butadiene.

10. A method for the manufacture of an electrode (E) according to claim 1, said method comprising:
step (1) of providing a metal substrate having at least one surface;
step (1b) of surface treatment of said at least one surface of said metal substrate to provide a surface-modified metal substrate having at least one side that is at least partially chemically modified;
step (2) of contacting at least one copolymer (A) obtained by radical polymerization of at least one phosphorus-containing unsaturated monomer with acrylic acid and/or methacrylic acid, with said at least one surface of said metal substrate, thus providing a first layer;
step (3) contacting said first layer with an electrode-forming composition, composition (CE), comprising at least one electrode active material, compound (AM), at least one binder, binder (B), and at least one solvent, solvent (S).

11. The method according to claim 10, wherein:
said step (1b) of surface treatment is performed via chemical etching; and/or
after step (1b) and before step (2), at least one step of cleaning and/or rinsing said at least one surface of said metal substrate is performed; and/or
after said step (2) and before step (3), at least one step of rinsing is performed; and/or
after said step (3), at least one step of drying and/or compression is performed.

12. The method according to claim 10, wherein said solvent (S) is an organic polar solvent.

13. An electrochemical device comprising a positive electrode and a negative electrode, wherein at least one of said positive electrode and said negative electrode is electrode (E) according to claim 1.

14. A method of producing a primer in a current collector of an electrochemical device comprising radical polymerization of at least one phosphorus-containing unsaturated monomer with acrylic acid and/or methacrylic acid to obtain at least one copolymer (A).

15. The electrode (E) according to claim 5, wherein said copolymer (A) is obtained by radical copolymerization of a mixture having the following molar ratio, based on the total quantity of acrylic acid, methacrylic acid and 2-hydroxyethyl methacrylate phosphates of Formula (a):
acrylic acid: from 80 to 90%,
methacrylic acid: from 5 to 15%,
2-hydroxyethyl methacrylate phosphates: from 2 to 10%.

16. The electrode (E) according to claim 5, wherein said copolymer (A) is obtained by radical copolymerization of a mixture having the following molar ratio, based on the total quantity of acrylic acid, methacrylic acid and 2-hydroxyethyl methacrylate phosphates of Formula (a):
acrylic acid: from 83 to 85%,
methacrylic acid: from 11 to 13%,
2-hydroxyethyl methacrylate phosphates: from 2 to 6%.

17. The method according to claim 10, wherein said solvent (S) is an organic polar solvent selected from the group consisting of: N-methyl-2-pyrrolidone (NPM), N,N-dimethylformamide, N,N-dimethylacetamide, dimethylsulfoxide, hexamethylphosphamide, dioxane, tetrahydrofuran, tetramethylurea, triethyl phosphate, trimethyl phosphate and mixtures thereof; and isobutyl-nitrile, isobutyl-butyrate, dibutylether, methyl isobutyl ketone, dibutyl carbonate, tert-butyl acetoacetate.

18. The electrochemical device according to claim 13, wherein the electrochemical device is a secondary battery.
